(19) United States
(12) Patent Application Publication
(10) Pub. No.: US 2015/0046235 A1
(43) Pub. Date: Feb. 12, 2015

(54) INTERSTITIAL CONTENT ITEM REVENUE SHARING

(71) Applicant: Google Inc., Mountain View, CA (US)

(72) Inventors: Timothy O'Connor, Moraga, CA (US); John Sung Joon Park, San Francisco, CA (US)

(73) Assignee: Google Inc., Mountain View, CA (US)

(21) Appl. No.: 13/964,699

(22) Filed: Aug. 12, 2013

(51) Int. Cl. G06Q 30/02

(52) U.S. Cl. CPC G06Q 30/0274
USPC 705/14.7

(57) ABSTRACT

Methods, systems, and apparatus, including computer programs encoded on a computer storage medium, for interstitial content item revenue sharing. In one aspect, a method includes identifying an interstitial content item that was presented during a particular device session; identifying two or more participating resources that were requested during the particular device session; determining that two or more different participating publishers are associated with the two or more participating resources, each participating publisher being a publisher that has been approved to receive revenue for presentation of interstitial content items; and assigning a revenue share value to each of the two or more participating publishers, each revenue share value specifying a portion of interstitial revenue that the participating publisher is allocated for display of the interstitial content item.

### BACKGROUND

This specification relates to content distribution.

The Internet has enabled access to a wide variety of resources, e.g., video and/or audio files, web pages for particular subjects, news articles, etc. Access to these resources has likewise enabled opportunities to provide additional content with the resources. For example, a user device may request a resource, such as a news web page from a news publisher, by submitting a resource request to the publisher. The web page can include instructions that cause the user device to request content items for presentation with the web page. Content items that may be of interest to a user can be identified by a content management system in response to the request. The request can include information the content management system can use to identify content items to be provided to the user device in response to the request.

### SUMMARY

In general, one innovative aspect of the subject matter described in this specification can be embodied in methods that include the actions of identifying an interstitial content item that was presented during a particular device session; identifying two or more participating resources that were requested during the particular device session; determining that two or more different participating publishers are associated with the two or more participating resources, each participating publisher being a publisher that has been approved to receive revenue for presentation of interstitial content items; and assigning a revenue share value to each of the two or more participating publishers, each revenue share value specifying a portion of interstitial revenue that the participating publisher is allocated for display of the interstitial content item. Other embodiments of this aspect include corresponding systems, apparatus, and computer programs, configured to perform the actions of the methods, encoded on computer storage devices.

These and other embodiments can each optionally include one or more of the following features. The two or more participating resources may include a destination resource that was presented subsequent to the interstitial content item.

Identifying two or more participating resources that were requested during the particular device session may comprise: identifying, from a plurality of resources requested during the particular device session, two or more consecutive resources that are each associated with a participating publisher, where at least one of the consecutive resources is the destination resource; and identifying, as the two or more participating resources, the consecutive resources.

Assigning a revenue share value to each of the two or more participating publishers may comprise: identifying, for each of the two or more participating resources, a distance of the participating resource from the destination resource; and for each of the two or more participating publishers, assigning the revenue share to the participating publisher based on the distance of each participating resource associated with the participating publisher relative to the distance of each other participating resource that is not associated with the participating publisher.

The distance for each participating resource may be measured by a number of resource requests between the participating resource and the destination resource. The distance for each participating resource may be measured by an amount of elapsed time between a request for the participating resource and a request for the destination resource.

The destination resource may have caused presentation of the interstitial content item prior to presentation of the destination resource.

Each participating resource may be a resource that i) does not include a content item slot for displaying a banner content item, and ii) is provided by a participating publisher.

Each participating publisher may have been approved to receive revenue for presentation of interstitial content items based on the participating publisher's agreement to provide participating resources.

Particular embodiments of the subject matter described in this specification can be implemented so as to realize none, one, or more of the following advantages. Sharing revenue generated by presentation of interstitial content items with participating publishers (e.g., publishers that agree to share revenue and provide resources that don't include banner advertisements) provides publishers with an incentive to provide participating resources (e.g., resources that don't include banner advertisements). Participating resources may have less prominent slots for content items, allowing a participating publisher to utilize space in participating resources for publisher provided content rather than presentation of third party content items. Various revenue sharing methods also promote cross-promotion between participating publishers, resulting in shared revenue for participating publishers who promote participating resources of other participating publishers. Users who visit participating resources may be provided with more prominent content provided by the publisher of the resource than a non-participating resource that may provide third party content items with more prominence than publisher provided content. Content item providers are provided with opportunities to have content items presented at user devices without competing for a user's attention with other content at the same time. Users may be more willing and able to be attentive to interstitial content items presented between resources of participating publishers due to the lack of prominent third party content items on the participating publisher pages. Providing interstitial content items of interest to users may, in turn, lead to satisfaction of users' informational needs.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which interstitial content item revenue sharing can occur.

FIG. 2 is a block diagram of an example data flow for requesting and receiving resources and interstitial content items.

FIG. 3A is an illustration of an example device session.

FIG. 3B is a block diagram of an example data flow for assigning revenue for an interstitial content item.

FIG. 4 is a flow diagram of an example process in which revenue is assigned for an interstitial content item.

FIG. 5 is a block diagram of an example data processing apparatus.

Like reference numbers and designations in the various drawings indicate like elements.

### DETAILED DESCRIPTION

A content management system assigns a portion of revenue, which is referred to as a revenue share, to participating publishers for an impression of an interstitial content item. An interstitial content item is a content item provided to user a device for display between presentations of resources of participating publishers. The content management system provides a user device with an interstitial content item, and identifies participating publishers whose resources were previously and/or subsequently visited by the user device during the same device session in which the interstitial content item was provided. In turn, the content management system can assign a portion of the revenue for the impression of the interstitial content item to each of the participating publishers.

For example, when navigating to a web page of a participating publisher, a user device may send a request for an interstitial advertisement to the content management system. Upon receipt of the request, the content management system determines whether to serve the user device an interstitial advertisement based on various factors, such as the publisher of the website that the user device just requested, which is referred to as the destination resource, and when the user last saw an advertisement. After providing the interstitial ad to the user device, the content management system determines which publishers are entitled to advertising revenue for serving the interstitial advertisement. For example, the content management system can identify participating publishers that have web pages which were visited by the user device during the same device session in which the interstitial ad was provided to the user device. Participating publishers may be, for example, publishers who have agreed to display no advertisements on their web pages, or no banner advertisements on their web pages, in exchange for receiving revenue from the interstitial ads. Participating publishers may also be publishers that have agreed to other conditions or restrictions regarding the placement of content items on their web pages (or other resources). For example, a publisher that agrees to only present content items at specified portions of their web page (e.g., below the fold) or at specified times of day can be participating resources.

Revenue can be assigned to the identified participating publishers based on several factors, such as how close a visit to a particular publisher's web page was (in time or in a chain of web page visits) to the serving of the interstitial ad, and whether or not any non-participating publisher web pages were viewed during the device session.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content management system that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content management system.

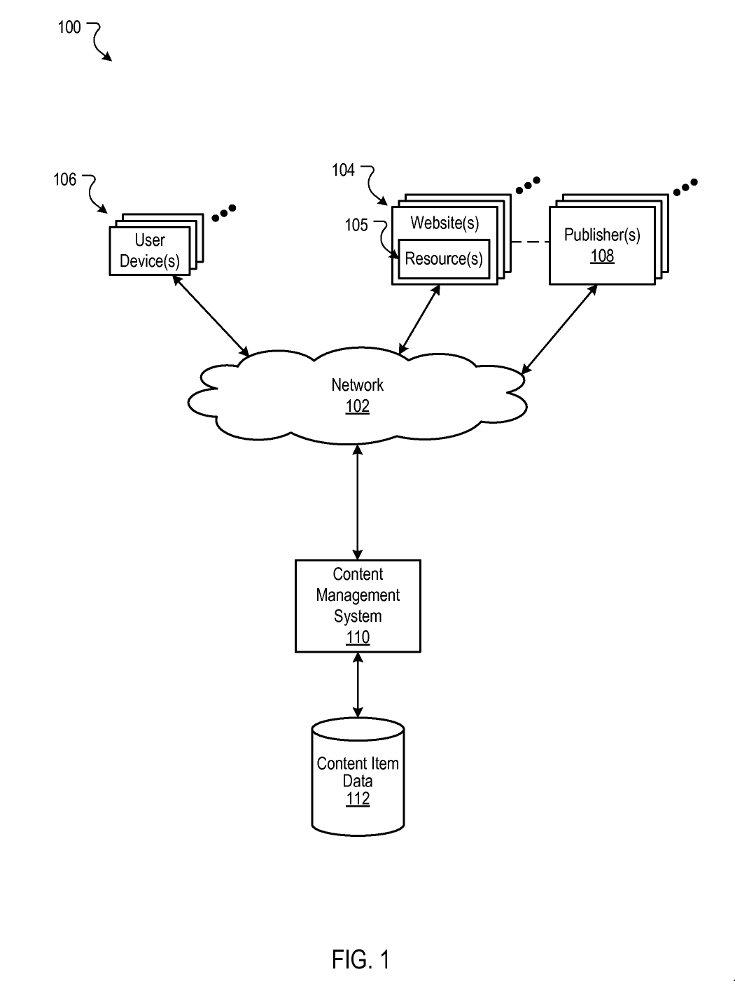

FIG. 1 is a block diagram of an example environment 100 in which interstitial content item revenue sharing can occur. A computer network 102, such as a local area network (LAN), wide area network (WAN), the Internet, or a combination thereof, connects publisher web sites 104, user devices 106, publishers 108, and a content management system 110. The online environment 100 may include many thousands of publisher web sites 104 and user devices 106.

A website 104 includes one or more resources 105 associated with a domain name and hosted by one or more servers. An example website is a collection of web pages formatted in hypertext markup language (HTML) that can contain text, images, multimedia content, and programming elements, such as scripts. Each website 104 is maintained by a content publisher 108, which is an entity that controls, manages and/or owns the website 104.

A resource 105 is data that can be provided by the publisher 108 over the network 102 and that is associated with a resource address. Resources include HTML pages, word processing documents, and portable document format (PDF) documents, images, video, and feed sources, to name just a few. The resources can include content, such as words, phrases, pictures, and so on, and may include embedded information (such as meta information and hyperlinks) and/or embedded instructions (such as scripts).

A user device 106 is an electronic device capable of requesting and receiving resources over the network 102. Example user devices 106 include personal computers, mobile communication devices, and other devices that can send and receive data over the network 102. A user device 106 typically includes a user application, such as a web browser, to facilitate the sending and receiving of data over the network 102. The web browser can enable a user to display and interact with text, images, videos, music and other information typically located on a web page at a website.

The user devices 106 submit requests for resources 105 of a particular website from the publisher of that website. The request may include a unique identifier that identifies the user device 106 that submits the request. The unique identifier can be data from a cookie stored at the user device, or a user account identifier if the user maintains an account with the publisher, or some other identifier that identifies the user device 106 or the user using the user device.

The publisher of the web site 104 receives the request for the resource from the user device 106 and provides the resource to the requesting user device 106. The requesting user device may then render the resource for display to a user.

The content management system 110 controls distribution of content items with and between presentations of the resources 105. For example, the content management system 110 allows publishers to specify selection rules that take into account a context of a content item request to provide content items for the users. Example selection rules include keyword rules, in which content providers are enabled to provide bids for keywords that are present in either search queries sent to a search engine or webpage content. Content items that are associated with keywords having bids that result in an impression being awarded in response to an auction (or another selection process) are selected for presentation in content item slots of resources. Content items can be provided for many different resources, such as a search results page resource, or one of the resources 105 included in a publisher websites.

Content items may be provided in various forms. In some examples, content items may include graphical advertisements, such as banner ads, text, images, audio, video, or a combination of one of more of any of such components. Content items may include embedded information, such as embedded media, links, meta-information, and/or machine executable instructions. A content item impression refers to any form of presentation of a content item such that it is experienced by a user. In some examples, a content item impression may occur when a content item is displayed on a user device.

A content item slot is a portion of a resource that is populated with a requested content item. The content item slot can be populated, for example, in response to a request for the content item that is initiated by way of the user device executing code corresponding to the content item slot when the resource is rendered at the user device. As used throughout this document, a content item is a discrete unit of content that is provided for presentation at a user device from which a request for the content item originated. Example content items include audio files, video files, advertisements, or other units of content that can be presented with a requested resource. Content item slots may have properties limiting the types of content items which can be displayed in the content item slot. For example, a banner content item slot may be limited to content items that fit a certain height to width ratio, and a content item slot may restrict content items to those without audio or video.

An interstitial content item is a content item that is provided to a user device for display prior to display of a requested resource. In some implementations, the interstitial content item may be displayed for a predefined period of time, or until it is interacted with—e.g., selected by the user or dismissed. In some implementations, a resource requested by a user device includes instructions that cause the user device to request an interstitial content item from the content management system before the requested resource is displayed. For example, the requested resource can include instructions that cause the user device to request and present an interstitial content item prior to presenting content of the requested resource.

The request may include, for example, a publisher identifier, a device identifier that identifies the requesting user device 106, and/or keyword identifiers related to the content of the resource 105. The content management system 110, in turn, provides an interstitial content item to the requesting user device. Other methods may be used to provide interstitial content items to user devices, for example, instructions that cause the user device to request an interstitial content item may be provided by a resource the user device is currently viewing or from an application on the user device—such as a web browser.

When a user of a user device 106 interacts with or otherwise selects a content item, the user device 106 generates a request for a landing page of the content item, which is typically a webpage of the content item provider. For example, an advertiser may have a website that includes web pages, some of which are landing pages for the advertisements of the advertisers.

The content items can be provided for many different resources, such as the resources 105 of the publishers 108, and on a search results page resource. In some implementations, certain types of content items may only be presented for certain resources. For example, the content management system 110 may only provide interstitial content items to user devices that are visiting participating resources, or resources of a participating publisher. A content item provider, such as an advertiser, compensates the content management system 110 for distribution of interstitial content items to user devices. The content management system 110, in turn, can share the revenue received for presenting the content items with one or more publishers of resources associated with user devices' requests for content items.

The content management system 110 may designate certain publishers 108 as participating publishers if the publishers agree to certain conditions regarding the display of content items. For example, participating publishers may be required to provide participating resources that meet certain conditions regarding content items, such as agreeing to not display banner advertisements on their resources and/or agreeing to not allow audio or video content items to be provided with their resources. Participating publishers may also be required to agree to revenue sharing for impressions of interstitial content items. The relationship between the content management system 110, participating publishers, non-participating publishers, participating resources, and revenue sharing will be described in further detail below.

The content management system 110 is in communication with a data storage system that stores content item data 112, such as campaign data and performance data for content items. For example, the campaign data can specify content items, selection information, and budgeting information for content item providers. The campaign data may also include information regarding content item providers who are also participating publishers, such as which participating resources they provide. The performance data stores data indicating the performance of the content items that are served. Such performance data may include, for example, click through rates for content items, the number of impressions for content items, and the number of conversions for content items. Other performance data can also be stored.

The content item data 112 may be used as input parameters to a content item selection process, such as an auction. For example, the content management system 110, in response to a request for content items, can conduct an auction to select content items that are provided in response to the request. The content items may be ranked according to a score that, in some implementations, is a value determined based on a content item bid and one or more parameters specified in the content item data 112. One or more highest ranked content items resulting from the auction are selected and provided to the requesting user device.

The content item data 112 may include interaction data that stores data related to user device interactions with resources and/or content items. For example, in response to a user device's resource request, the user device or publisher of the requested resource may provide data to the content management system 110 that indicates a device identifier for the user device along with a timestamp and/or data specifying the requested resource. In response to a user device's content item request, the content management system 110 may store a device identifier for the corresponding user device in the interaction data along with a timestamp and/or data specifying the content item provided to the user device. In some implementations, publishers 108 provide the content management system 110 with data that specifies device identifiers and interactions recorded by the publisher for storage in the content item data 112.

As described in further detail below, the content management system 110 uses the content item data 112 to facilitate the distribution of interstitial content items to user devices 106 and to facilitate assigning revenue for the distribution of interstitial content items.

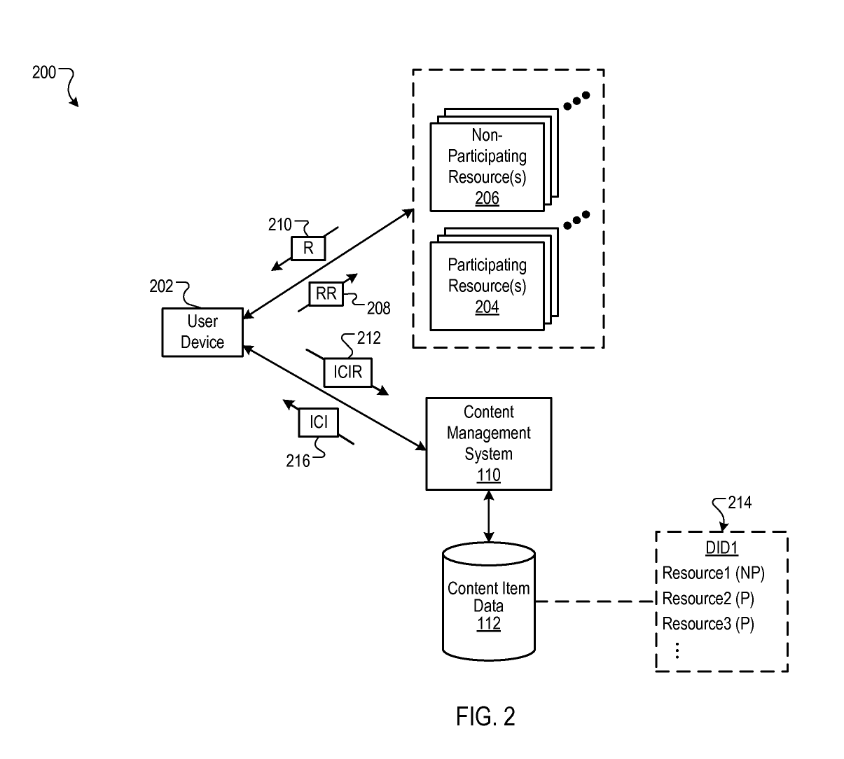

FIG. 2 is a block diagram of an example data flow 200 for requesting and receiving resources and interstitial content items. During a device session, a user device 202 can send resource requests 208 for both participating resources 204 and non-participating resources 206. The resources 210 provided to the user device 202 are rendered by the user device 202 for display to a user.

A device session includes data identifying resource and content item requests for a period of time. A device session can be for any length of time and for any number of resource and content item requests. In some implementations, a device session may span a period of time during which a user or user device is logged into a particular network or application. In some implementations, requests for particular resources or content items, or a particular category of resource or content item, may indicate the end or beginning of a device session. In some implementations, device sessions may span multiple browsing sessions of a user device. Other methods may be used to define and identify device sessions.

During a device session, the user device 202 sends requests for content items, including interstitial content item requests 212, to the content management system 110. In response, the content management system 110 selectively provides content items, including interstitial content items 216, to the user device 202. For example, each web page the user device 202 renders may include a script that causes the user device 202 to send a request for content items to the content management system 110.

The content management system 110 may also store, in the content item data 112, a record 214 of the resources visited by a user device 202 during a device session. For example, resource requests 208 and content item requests 212 can include a device identifier, e.g., “DID1,” that identifies the user device 202. In some implementations, publishers of the requested resources provide the content management system 110 with the device identifier and data indicating the particular resource requested. In some implementations, the content item requests 212 also include the device identifier and data indicating the resource for which content items are being requested. The content management system 110 can determine which resources requested by a user device 202 during a device session were participating resources, and which were not. In the example environment 200, the record 214 indicates that the device identifier, “DID1,” requested Resource1 (non-participating), Resource2 (participating), and Resource3 (participating). The order in which the resources were requested is also included in the record 214.

In some implementations, only participating resources or requests for participating resources cause the user device 202 to request interstitial content items. For example, when publishers provide participating resources, they may place a script on those participating resources that, when executed by a user device, causes the user device to request an interstitial content item from the content management system 110.

In some implementations, the content management system 110 selectively determines whether to provide an interstitial content item upon receipt of the interstitial content item request. For example, the content management system 110 may only provide an interstitial content item to a user device that has not recently been provided with an interstitial content item. As another example, an interstitial content item may only be provided to a user device after a predetermined number of resources and/or content items have been provided to the user device without presentation of an interstitial content item, e.g., an interstitial content item may only be provided to a user device that has not been provided with an interstitial content item in response to requests for the three most recently requested resources.

In some implementations, the content management system 110 may condition presentation of interstitial content items on a determination that at least two participating resources are consecutively requested. For example, if a device session begins with a user device visiting a non-participating resource, followed by a participating resource, no interstitial content item would be presented between the resources. In this example, if a third resource requested by the user device is a participating resource, an interstitial content item may be presented before presentation of the third resource, because there are at least two consecutively requested participating resources. Other numbers of consecutive participating resource requests may be used to throttle or condition presentation of interstitial content items.

In some implementations, an amount of elapsed time may be used to throttle or condition presentation of interstitial content items. For example, the content management system may be configured to provide an interstitial content item to a requesting user device only if the user device has not been provided with an interstitial content item within the preceding two minutes. Various combinations of time, number of requested resources, and/or consecutive participating resources may be used to throttle or condition presentation of interstitial content items.

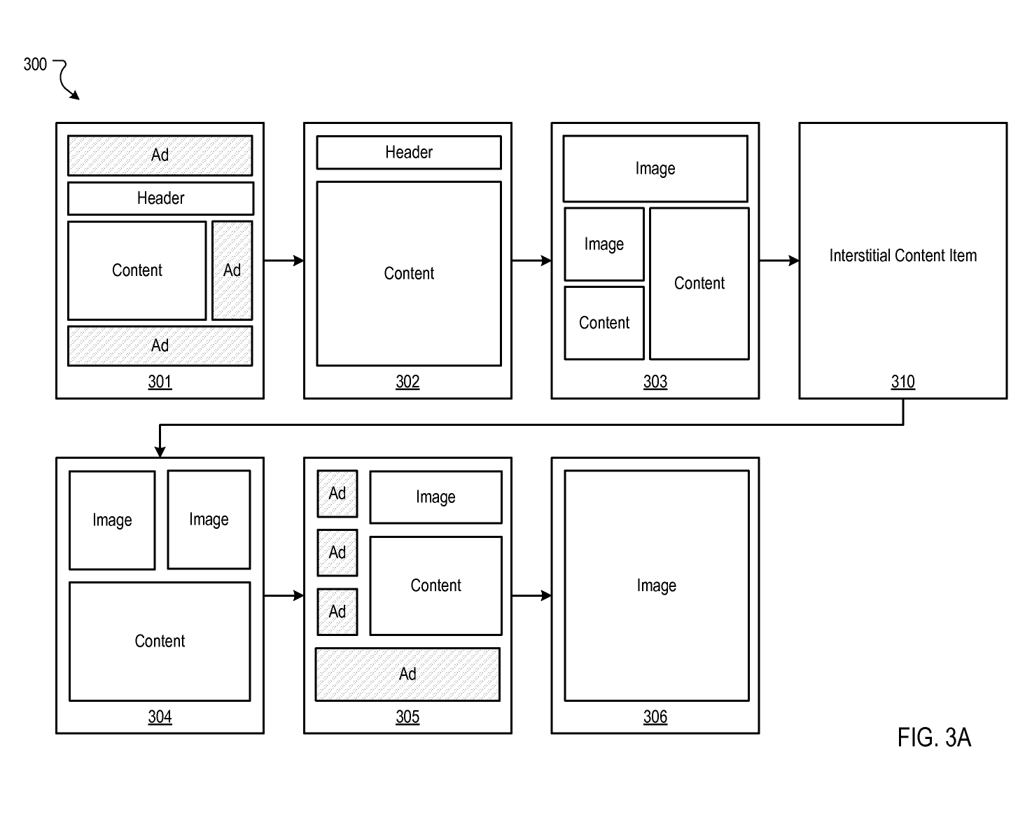

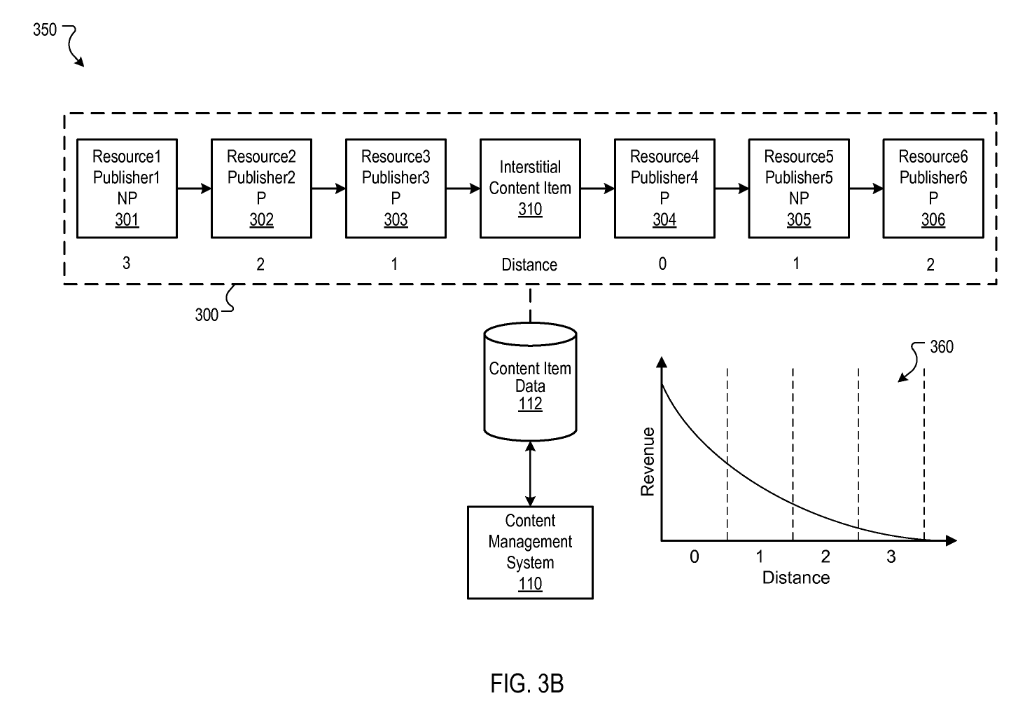

FIG. 3A is an illustration of an example device session 300, and FIG. 3B is a block diagram of an example data flow 350 for assigning revenue generated by presentation of an interstitial content item. The example device session 300 is illustrated in chronological order. Resource1 301 and Resource5 305 are non-participating resources, while Resource2 302, Resource3 303, Resource4 304, and Resource6 306 are participating content items. In FIG. 3B, participating and non-participating resources are identified by, respectively, a “P” and “NP.” As discussed above, participating resources are resources that are provided by a participating publisher and that meet certain conditions regarding content items presentation of content items. For example, a web page may only be a participating resource if it does not include an advertisement slot near (e.g., within a specified number of pixels of) the top of the page, or “above the fold.”

The content management system 110 identifies an impression of an interstitial content item 310 during the device session 300. In the example data flow 350, a record of the resources requested and interstitial content items presented during the device session 300 are stored in the content item data 112 and accessed by the content management system 110. For example, sessions logs may be stored for device sessions that included presentation of an interstitial content item, and the content management system 110 may identify interstitial advertisement impressions recorded in the session logs.

The content management system 110 identifies participating resources that were presented during the device session 300. In some implementations, the content management system 110 identifies all participating resources presented during a device session that included presentation of an interstitial content item. In some implementations, the content management system 110 identifies a proper subset of the participating resources that includes only those participating resources that meet certain requirements. For example, the content management system 110 may include in the proper subset only those participating resources that were presented prior to the presentation of the interstitial content item. In such an implementation, Resource2 302 and Resource3 303 in the example data flow 350 were presented prior to the presentation of the interstitial content item 310, and they may be the only participating resources identified for inclusion in the proper subset. As used herein, a presentation of a resource may include a resource request, as device session data may not, in some implementations, indicate whether a requested resource was actually presented at a user device.

In some implementations, the participating resources identified by the content management system 110 include a destination resource that was presented subsequent to the interstitial content item 310. In the example device session 300, resource4 304 is the destination resource that was presented subsequent to the interstitial content item 310. In some implementations, the destination resource is a participating resource that includes instructions that cause a user device provided with the resource to request display of an interstitial content item before the destination resource is displayed. For example, the interstitial content item may be in the form of a graphical overlay that is displayed on top of the destination resource, or it may be a separate web page.

In some implementations, the participating resources identified by the content management system 110 are consecutive participating resources, and at least one of the consecutive resources is the destination resource. In the example data flow 350, resource2 302, resource3 303, and resource4 304 may be the participating resources identified by the content management system 110 because they are consecutive participating resources and because resource4 304 is a destination resource.

Other criteria or combinations of criteria may be used to identify participating resources. For example, a distance in time or number of resource requests from the presentation of the interstitial content item 310 may be used to limit the number of participating resources identified. As another example, identification of participating resources may be limited to participating resources visited before presentation of the interstitial content item, or participating resources visited after presentation of the interstitial content item.

The content management system 110 determines that two or more participating publishers are associated with the participating resources that were identified by the content management system 110. As discussed above, each participating publisher is a publisher that has been approved to receive revenue for presentation of interstitial content items. For example, participating publishers that provide participating resources—e.g., resources that do not include advertisements or certain kinds of content items—may be approved by the content management system 110 to receive revenue for interstitial content item impressions.

In the example device session 300, Publisher2, Publisher3, Publisher4, and Publisher6 are all publishers of participating resources. Whether each participating publisher's corresponding resource was one of the participating resources identified by the content management system depends on the criteria used to identify the participating resources. For example, if the content management system identifies only consecutive participating resources, Resource6 would not be one of the identified resources because of intervening and non-participating Resource5 305, and the content management system would determine that Publisher6 is not associated with one of the identified participating resources.

The content management system 110 assigns a revenue share value to each of the participating publishers associated with the identified participating resources. Each revenue share value specifies a portion of the revenue the participating publisher is allocated for display of the interstitial content item. For example, if a content item provider pays the content management system 110 $1.00 for the impression of the interstitial content item 310, a portion of the revenue is assigned to each of the participating publishers of the identified resources presented during the device session 300.

In some implementations, revenue is assigned to the participating publishers based on the distance of each participating resource from the destination resource. In some implementations, distance is measured by a number of resource requests between the participating resource and the destination resource. In the example device session 300, the destination resource, Resource4 304, would have a distance of 0 from itself, while Resource3 303 has a distance of 1, Resource2 302 has a distance of 2, and Resource6 306 has a distance of 2. Accordingly, Resource4 304 may receive the greatest portion of revenue, resources Resource2 302 and Resource6 306 may receive the smallest portion of revenue, and Resource3 303 may receive a portion of revenue greater than Resource2 302 and Resource6 306, but less than Resource4 304.

In some implementations, distance is measure by an amount of elapsed time between a request for the participating resource and a request for the destination resource. For example, Resource2 302 and Resource6 306 are both two resource requests away from Resource4 304, but a difference in elapsed time may result in different revenue share values being assigned to the corresponding publishers. If 10 minutes elapsed between presentation of Resource2 302 and Resource4 304, but only 2 minutes elapsed between presentation of Resource4 304 and Resource6 306, then the Publisher6 may be assigned a greater share of revenue than Publisher2.

In some implementations, revenue is assigned to the participating publishers based on the distance of each participating resource from the presentation of the interstitial content item. In this implementation, Resource3 303 and Resource4 304 may both be the same distance from the impression of the interstitial content item 310. As with the destination resource, the distance from the interstitial content item 310 impression may be measured in resource requests and/or time.

Many methods may be used to determine the actual revenue share values assigned to each participating publisher. In some implementations, revenue share is a calculated based on a predetermined formula. A graph 360 of an example formula is depicted in the example data flow 250. The graph 360 indicates that revenue decreases as distance increases until no revenue is assigned past a distance of 3. In some implementations, revenue share may be split equally among the participating publishers. In some implementations, revenue share values are calculated relative to the distance of each other participating resource. For example, in a situation with two participating resources, where a first resource is a destination resource with a distance of 0, and a second resource is a participating resource with a distance of 3, the publisher of the first resource may be assigned a larger revenue share value than if the second resource had a distance of 1.

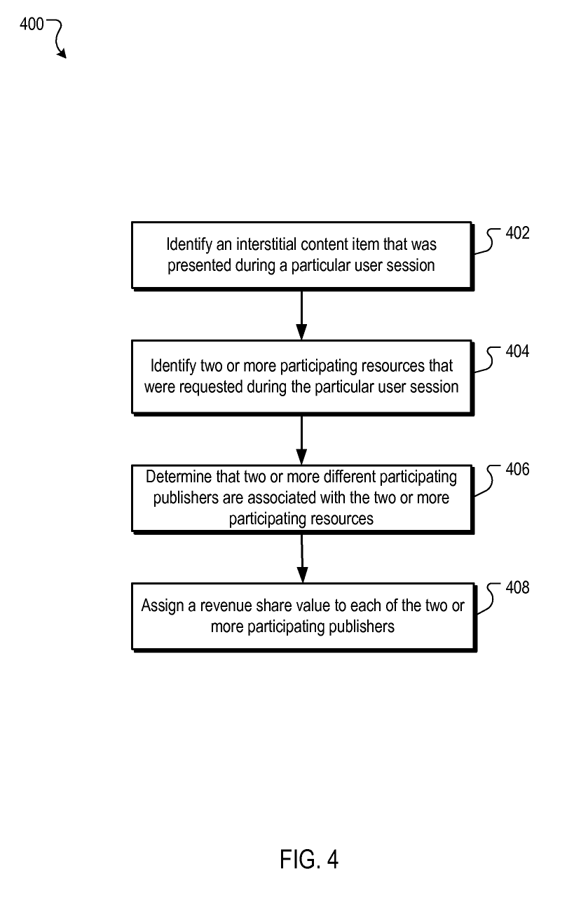

FIG. 4 is a flow diagram of an example process 400 in which revenue is from an interstitial content item is assigned to participating publishers. The process 400 may be implemented by data processing apparatus, such as the content management system.

An interstitial content item that was presented during a particular device session is identified (402). For example, impressions of interstitial content items may be recorded in a data storage device along with additional information related to the impression, such as device session data that describes other content items and resources provided to a user device during the same device session in which the interstitial content item was presented.

Two or more participating resources that were requested during the particular device session are identified (404). In some implementations, various criteria may be used to determine which participating resources will be identified. For example, while many participating resources may be part of a device session in which an interstitial content item was displayed, only consecutive participating resources that are within a threshold distance of the impression of the interstitial content item may be identified. In some implementations, a participating resource is a resource that i) does not include a content item slot for displaying a banner content item, and ii) is provided by a participating publisher. As described above, participating resources may be identifiable based on other or additional criteria. For example, participating resources may, in some implementations, not have any content item slots, or may have no content item slots “above the fold.”

In some implementations, the identified participating resources include a destination resource that was presented subsequent to the interstitial content item. For example, when a user device requests a resource, if the resource is a participating resource it may include data that, when executed by the user device, causes the user device to request and display an interstitial content item before the requested resource is presented. The requested participating resource is the destination resource, and it may be presented after the interstitial content item has either been selected or dismissed.

The process 400 determines that two or more different participating publishers are associated with the two or more participating resources (406). In some implementations, a participating publisher is a publisher that has been approved to receive revenue for presentation of interstitial content items. In some implementations, each participating publisher has been approved to receive revenue for presentation of interstitial content items based on the participating publisher's agreement to provide a resource that complies with conditions required to qualify as a participating resource and to share revenue generated by interstitial content items. For example, if five different participating resources are identified, the publisher of each resource may have previously agreed to share revenue obtained for the interstitial content item impression with other participating publishers whose participating resources were also presented during the device session.

A revenue share value is assigned to each of the two or more participating publishers (408). For example, if there are five participating resources identified for a particular impression of an interstitial content item, and the five participating resources were provided by three different participating publishers, a revenue share value can be assigned to each of the participating publishers. In situations where a single participating publisher is associated with all of the participating resources identified for the device session, the single participating publisher may be the only publisher to whom a revenue share value is assigned.

In some implementations, assigning a revenue share value includes identifying, for each participating resource, a distance of the participating resource from a destination resource and for each participating publisher, assigning revenue share based on the distance of each participating resource associated with the participating publisher relative to the distance of each other participating resource that is not associated with that participating publisher. Using the example of five participating resources provided by three different publishers, if one of the publishers provided the destination resource and the two resources nearest the destination resource, that publisher may be entitled to the majority of the revenue. However, if the publisher's three participating resources were all further from the destination resource than the other two participating resources, the publisher may not receive the majority of the revenue, despite providing three of the five participating resources.

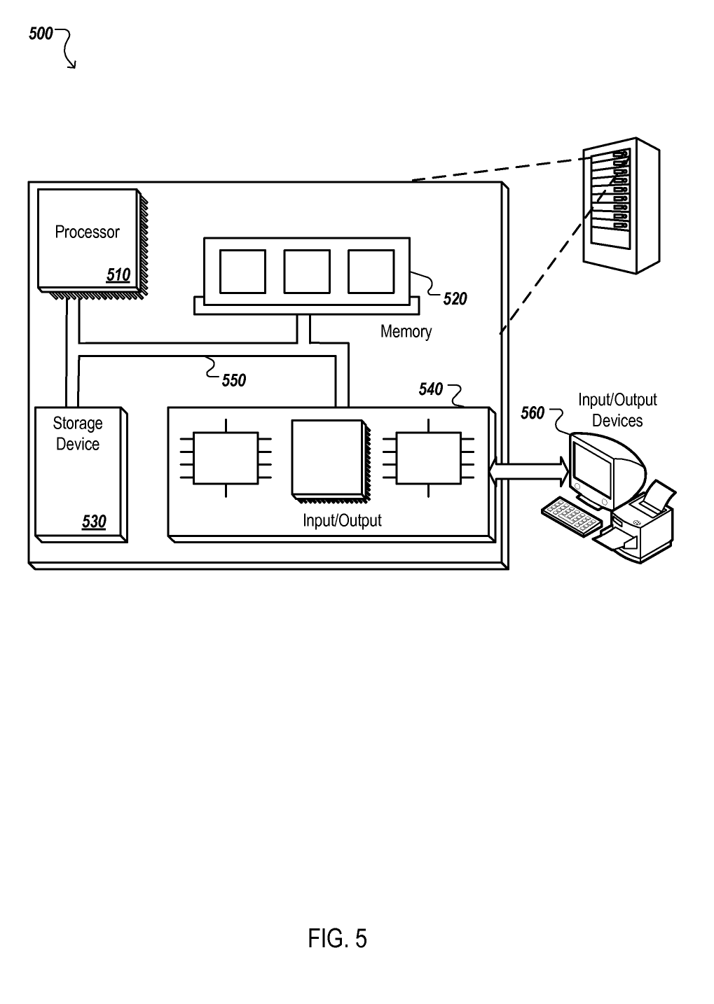

FIG. 5 is a block diagram of an example data processing apparatus 500. The system 500 includes a processor 510, a memory 520, a storage device 530, and an input/output device 540. Each of the components 510, 520, 530, and 540 can, for example, be interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can, for example, include a hard disk device, an optical disk device, or some other large capacity storage device.

The input/output device 540 provides input/output operations for the system 500. In one implementation, the input/output device 540 can include one or more network interface devices, e.g., an Ethernet card, a serial communication device, e.g., an RS-232 port, and/or a wireless interface device, e.g., an 802.11 card. In another implementation, the input/output device can include driver devices configured to receive input data and send output data to other input/output devices, e.g., keyboard, printer and display devices 560. Other implementations, however, can also be used, such as mobile computing devices, mobile communication devices, set-top box television client devices, etc.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., a FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a user computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method implemented by data processing apparatus, the method comprising:
identifying an interstitial content item that was presented during a particular device session;
identifying two or more participating resources that were requested during the particular device session;
determining that two or more different participating publishers are associated with the two or more participating resources, each participating publisher being a publisher that has been approved to receive revenue for presentation of interstitial content items; and
assigning a revenue share value to each of the two or more participating publishers, each revenue share value specifying a portion of interstitial revenue that the participating publisher is allocated for display of the interstitial content item.

2. The method of claim 1, wherein the two or more participating resources include a destination resource that was presented subsequent to the interstitial content item.

3. The method of claim 2, wherein identifying two or more participating resources that were requested during the particular device session comprises:
identifying, from a plurality of resources requested during the particular device session, two or more consecutive resources that are each associated with a participating publisher, where at least one of the consecutive resources is the destination resource; and
identifying, as the two or more participating resources, the consecutive resources.

4. The method of claim 2, wherein assigning a revenue share value to each of the two or more participating publishers comprises:
identifying, for each of the two or more participating resources, a distance of the participating resource from the destination resource; and
for each of the two or more participating publishers, assigning the revenue share to the participating publisher based on the distance of each participating resource associated with the participating publisher relative to the distance of each other participating resource that is not associated with the participating publisher.

5. The method of claim 4, wherein the distance for each participating resource is measured by a number of resource requests between the participating resource and the destination resource.

6. The method of claim 4, wherein the distance for each participating resource is measured by an amount of elapsed time between a request for the participating resource and a request for the destination resource.

7. The method of claim 2, wherein the destination resource caused presentation of the interstitial content item prior to presentation of the destination resource.

8. The method of claim 1, wherein each participating resource is a resource that i) does not include a content item slot for displaying a banner content item, and ii) is provided by a participating publisher.

9. The method of claim 8, wherein each participating publisher has been approved to receive revenue for presentation of interstitial content items based on the participating publisher's agreement to provide participating resources.

10. A system comprising:
a data processing apparatus; and
a data store storing instructions that, when executed by the data processing apparatus, cause the data processing apparatus to perform operations comprising:
identifying an interstitial content item that was presented during a particular device session;
identifying two or more participating resources that were requested during the particular device session;
determining that two or more different participating publishers are associated with the two or more participating resources, each participating publisher being a publisher that has been approved to receive revenue for presentation of interstitial content items; and
assigning a revenue share value to each of the two or more participating publishers, each revenue share value specifying a portion of interstitial revenue that the participating publisher is allocated for display of the interstitial content item.

11. The system of claim 10, wherein the two or more participating resources include a destination resource that was presented subsequent to the interstitial content item.

12. The system of claim 11, wherein identifying two or more participating resources that were requested during the particular device session comprises:
identifying, from a plurality of resources requested during the particular device session, two or more consecutive resources that are each associated with a participating publisher, where at least one of the consecutive resources is the destination resource; and
identifying, as the two or more participating resources, the consecutive resources.

13. The system of claim 11, wherein assigning a revenue share value to each of the two or more participating publishers comprises:
identifying, for each of the two or more participating resources, a distance of the participating resource from the destination resource; and
for each of the two or more participating publishers, assigning the revenue share to the participating publisher based on the distance of each participating resource associated with the participating publisher relative to the distance of each other participating resource that is not associated with the participating publisher.

14. The system of claim 13, wherein the distance for each participating resource is measured by a number of resource requests between the participating resource and the destination resource.

15. The system of claim 13, wherein the distance for each participating resource is measured by an amount of elapsed time between a request for the participating resource and a request for the destination resource.

16. The system of claim 11, wherein the destination resource caused presentation of the interstitial content item prior to presentation of the destination resource.

17. The system of claim 10, wherein each participating resource is a resource that i) does not include a content item slot for displaying a banner content item, and ii) is provided by a participating publisher.

18. The system of claim 17, wherein each participating publisher has been approved to receive revenue for presentation of interstitial content items based on the participating publisher's agreement to provide participating resources.

19. A computer readable medium storing instructions that, when executed by a data processing apparatus, cause the data processing apparatus to perform operations comprising:
identifying an interstitial content item that was presented during a particular device session;
identifying two or more participating resources that were requested during the particular device session;
determining that two or more different participating publishers are associated with the two or more participating resources, each participating publisher being a publisher that has been approved to receive revenue for presentation of interstitial content items; and
assigning a revenue share value to each of the two or more participating publishers, each revenue share value specifying a portion of interstitial revenue that the participating publisher is allocated for display of the interstitial content item.

20. The computer readable medium of claim 19, wherein assigning a revenue share value to each of the two or more participating publishers comprises:
identifying, for each of the two or more participating resources, a distance of the participating resource from the destination resource; and
for each of the two or more participating publishers, assigning the revenue share to the participating publisher based on the distance of each participating resource associated with the participating publisher relative to the distance of each other participating resource that is not associated with the participating publisher.
